(19) United States
(12) Patent Application Publication
(10) Pub. No.: US 2013/0132810 A1
(43) Pub. Date: May 23, 2013

(54) WINDOW TAGS GRAPHIC DISPLAY

(71) Applicant: Thomas E. Jandt, Corona, CA (US)

(72) Inventor: Thomas E. Jandt, Corona, CA (US)

(73) Assignee: THOMAS JANDT & ASSOCIATES, INC., Corona, CA (US)

(21) Appl. No.: 13/465,993

(22) Filed: May 7, 2012

Related U.S. Application Data
(60) Provisional application No. 61/561,308, filed on Nov. 18, 2011.

(51) Int. Cl. G09F 7/00; G09F 13/00; G06F 17/00

(52) U.S. Cl. 715/209; 40/606.01; 40/611.01; 40/541

(57) ABSTRACT

A frame mounts to a display surface for supporting an interactive sign with a first surface and a second surface, which faces the display surface. The frame includes a front and back side. The back side faces the display surface. The front side includes an opening that covers at least two opposite edges of the interactive sign. The frame includes a top, bottom, right, and left edges. The frame includes a lip portion positioned along at least one edge of the frame. An adhesive material connects to the back side of the frame. The adhesive material forms a connection to the display surface. The adhesive material is applied to at least two edges of the frame. At least part of the lip portion of the frame is sized so a combined thickness of the lip portion and the adhesive material is greater than a thickness of the interactive sign.

### CROSS-REFERENCES TO RELATED APPLICATIONS

This application claims the benefit of U.S. Provisional Patent Application No. 61/561,308 entitled “Window Tags Graphic Display” and filed on Nov. 18, 2011 for Thomas Edward Jandt, which is incorporated herein by reference.

### FIELD OF THE INVENTION

This invention relates to a graphic display for a smooth surface. More particularly, the invention relates to a graphic display for displaying an interactive sign on a window or other smooth surface.

### BACKGROUND

Photographs, printed signs, and bumper stickers are a popular way to show support for a school, organization, or political candidate. Signs are also used to advertise the sale of a product, home, or vehicle. Traditional signs provide only a small amount of information, and are limited by the size of the surface of the sign. Traditionally, these kinds of signs are attached to windows, vehicle bumpers, or placed in yards. Signs are often unattractive or worse. Age and exposure to the elements cause signs to deteriorate, fade, or become misshapen and deformed. Signs such as bumper stickers are difficult to remove, and may damage the surface that they were previously attached to.

### SUMMARY

From the foregoing discussion, it should be apparent that a need exists for an apparatus, system, and method for displaying an interactive sign. Beneficially, such an apparatus, system, and method would provide an easy way for individuals or organizations to easily and attractively display an interactive sign.

The present invention has been developed in response to the present state of the art, and in particular, in response to the problems and needs in the art that have not yet been fully solved by currently available signs and sign holders. Accordingly, the present invention has been developed to provide an apparatus, system, and method for displaying an interactive sign that overcome many or all of the above-discussed shortcomings in the art.

The apparatus to display an interactive sign includes a frame that mounts to a display surface for supporting an interactive sign. The sign includes a first surface and a second surface. The second surface faces the display surface. The frame includes a front side and a back side. The back side of the frame faces the display surface. The front side of the frame includes an opening sized such that the opening covers at least two opposite edges of the first surface of the interactive sign to retain the interactive sign. The frame includes a top edge, a bottom edge, a right edge, and a left edge (“edges of the frame”). The frame includes a lip portion positioned along at least one edge of the frame.

The apparatus includes an adhesive material connected to the back side of the frame. The adhesive material forms a connection to the display surface when mounted to the display surface. The adhesive material is applied to at least two edges of the frame. At least part of the lip portion of the frame is sized such that a combined thickness of the lip portion and the adhesive material is greater than a thickness of the interactive sign.

The apparatus, in one embodiment, further includes a retention apparatus shaped to secure the interactive sign. The retention apparatus is connected to an edge of the frame free of a lip portion and positioned between the back side of the frame and the display surface.

In a further embodiment, the interactive sign includes an interactive element that interacts with a mobile scanning device. In an additional embodiment, the interactive element includes one or more of a quick response (“QR”) code, a bar code, or a radio frequency identification (“RFID”) tag. In another embodiment, the interactive element is located on a surface of the interactive sign and within the opening in the frame. In a further embodiment, the interactive element is printed directly on a surface of the interactive sign. In an additional embodiment, the interactive element is printed on a sheet separate from the interactive sign that is affixed to the surface of the interactive sign. The frame, in one embodiment, includes a compartment configured to receive an RFID tag.

In another embodiment, the frame flexes to allow the interactive sign to be positioned within the frame. In an additional embodiment, the frame includes a lip portion positioned along four edges of the frame. In a further embodiment, at least one edge of the frame includes a slot configured to allow insertion or removal of an interactive sign.

In an additional embodiment, the adhesive material is applied to three edges of the frame on the lip portion of the frame. In another embodiment, the lip or the adhesive material includes at least one gap between the interactive sign and an outer edge of the frame. In another embodiment, the opening covers four edges of the interactive sign to retain the interactive sign. In a further embodiment, the lip portion of the frame includes a slot configured to receive the interactive sign. In another embodiment, the slot is positioned along one or more of the edges of the frame.

The apparatus, in one embodiment, includes one or more lights integrated with the frame positioned to project light onto a surface of the interactive sign. In another embodiment, the one or more lights include one or more of light emitting diodes (“LEDs”), organic light-emitting diodes (“OLED s”), light-emitting capacitors (“LECs”), liquid crystal displays (“LCDs”), cold-cathode fluorescent lamps (“CCFLs”), and cold cathode devices. In another embodiment, the apparatus includes a transparent element sized to fit inside the opening of the frame so as to fill either a portion of the opening or the entire opening.

A method of the present invention is also presented for displaying an interactive sign. The method in the disclosed embodiments substantially includes the steps necessary to carry out the functions presented above with respect to the operation of the described apparatus and system. In one embodiment, the method includes receiving a uniform resource locator (“URL”) for a web page. The web page, in one embodiment, includes information about an item including a display surface. The method also may include generating an interactive element associated with the URL.

In a further embodiment, the method includes incorporating the interactive element with a surface of an interactive sign. In another embodiment, the method includes supporting the interactive sign on a frame mounted to the display surface of the item. In a further embodiment, the method includes a frame mounted to the display surface of the item supporting an interactive sign. The sign, in a further embodiment, includes a first surface and a second surface. In another embodiment, the second surface faces the display surface.

In one embodiment, the frame includes a front side and a back side. In an additional embodiment, the back side of the frame faces the display surface. In a further embodiment, the front side of the frame includes an opening sized such that the opening covers at least two opposite edges of the first surface of the interactive sign to retain the interactive sign. In one embodiment, the frame includes a top edge, a bottom edge, a right edge, and a left edge (“edges of the frame”). In another embodiment, the frame includes a lip portion positioned along at least one edge of the frame.

The frame, in one embodiment, includes an adhesive material connected to the back side of the frame. In another embodiment, the adhesive material forms a connection to the display surface when mounted to the display surface. In an additional embodiment, the adhesive material is applied to at least two edges of the frame. In one embodiment, at least part of the lip portion of the frame is sized such that a combined thickness of the lip portion and the adhesive material is greater than a thickness of the interactive sign.

A system of the present invention is also presented to display an interactive sign. The system may be embodied. In particular, the system, in one embodiment, includes an interactive sign. In another embodiment, the sign includes a first surface and a second surface. The system may also include an interactive element associated with a URL for a web page. In an additional embodiment, the web page includes information about an item. In a further embodiment, the item includes a display surface. In another embodiment, the interactive element is incorporated with a surface of the interactive sign.

The system may further include a frame that mounts to a display surface for supporting the interactive sign. In one embodiment, the frame includes a front side and a back side. In another embodiment, the back side of the frame faces the display surface. In a further embodiment, the second surface of the interactive sign faces the display surface. In an additional embodiment, the front side of the frame includes an opening sized such that the opening covers at least two opposite edges of the first surface of the interactive sign to retain the interactive sign. In one embodiment, the frame includes a top edge, a bottom edge, a right edge, and a left edge (“edges of the frame”). In another embodiment, the frame includes a lip portion positioned along at least one edge of the frame.

The system, in one embodiment, may further include an adhesive material connected to the back side of the frame. In another embodiment, the adhesive material forms a connection to the display surface when mounted to the display surface. In a further embodiment, the adhesive material is applied to at least two edges of the frame. The system, in another embodiment, may include at least part of the lip portion of the frame sized such that a combined thickness of the lip portion and the adhesive material is greater than a thickness of the interactive sign.

The system, in a further embodiment, includes a URL receiving module that receives a URL of a web page. In another embodiment, the web page includes information about an item including a display surface. In an additional embodiment, the system includes an interactive element generation module that generates an interactive element associated with the URL. In one embodiment, the system includes an interactive element incorporation module that incorporates the interactive element generated by the interactive element generation module with a surface of the interactive sign.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts one embodiment of an apparatus for displaying an interactive sign in accordance with the present invention;

FIG. 2 depicts an angled view of the back side of one embodiment of a frame in accordance with the present invention;

FIG. 3 depicts an angled view of the front side of one embodiment of a frame in accordance with the present invention;

FIG. 4 depicts a back side of an embodiment of a frame in a square shape in accordance with the present invention;

FIG. 5 depicts a back side of an embodiment of a frame in a rectangular shape in accordance with the present invention;

FIG. 6 depicts the first surface of one embodiment of an interactive sign in accordance with the present invention;

FIG. 7 depicts the front side of one embodiment of an apparatus for displaying an interactive sign in accordance with the present invention;

FIGS. 8A and 8B depict different views of one embodiment of a frame in accordance with the present invention;

FIG. 9 depicts a method for displaying an interactive sign in accordance with the present invention;

FIG. 10 depicts a system for displaying an interactive sign in accordance with the present invention;

FIG. 11 depicts another embodiment of a system for displaying an interactive sign in accordance with the present invention;

FIG. 12 depicts a close up view of the corner of one embodiment of the rear side of a frame in accordance with the present invention;

FIG. 13 depicts an embodiment of an interactive sign that includes an RFID tag in accordance with the present invention;

FIG. 14 depicts a cross section of one portion of a frame in accordance with the present invention;

FIG. 15 depicts an embodiment of an apparatus that includes lights integrated with the frame; and

FIG. 16 depicts one embodiment of the apparatus that includes a transparent element sized to fit the opening of the frame in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

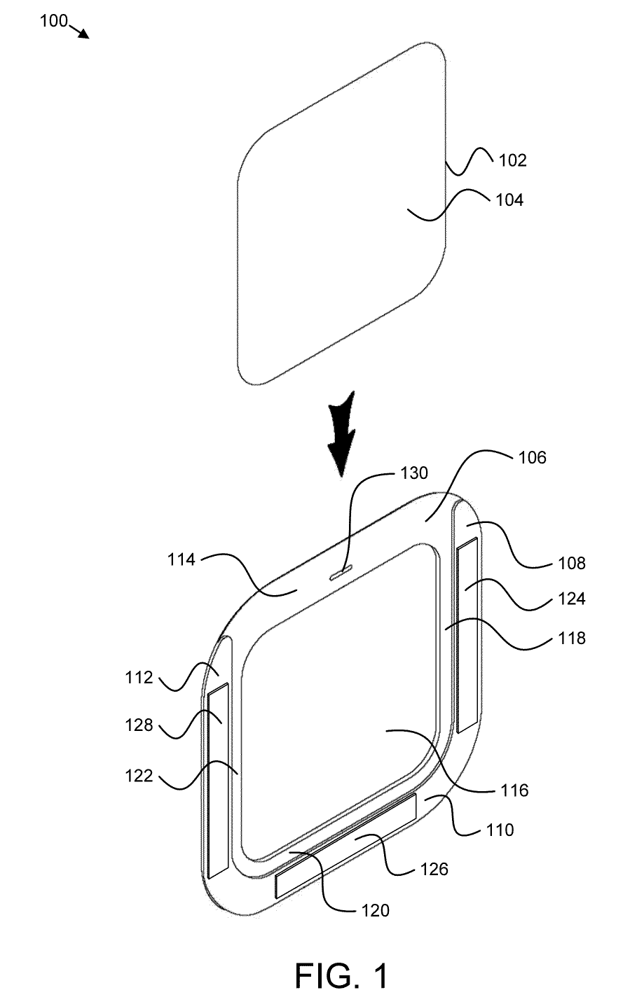

FIG. 1 depicts one embodiment of an apparatus 100 for displaying an interactive sign. The apparatus 100 includes an interactive sign 102. The interactive sign 102 includes a first surface and a second surface 104. In various embodiments, the interactive sign 102 could be made of plastic, PVC, paper, metal, wood, or another material.

The interactive sign 102, in one embodiment, includes information printed on the first surface of the interactive sign 102. The information printed on the first surface could, in various embodiments, include political information, contact information, sales information, pictures, text, designs, a business name, logo, phone number, promotional content, or the like. Other possible information could include graphics of national sports teams, election candidates, for sale signs, astrological signs, realtor signs, business logos, oversized business cards, popular phrases, or any other design or expression that an individual may wish to display. In one embodiment, the interactive sign 102 could include sales information for assisting in the sale of a new or used car, such as the car's make, model, year, mileage, and seller contact information. In another embodiment, the interactive sign 102 could include support for a particular political candidate or platform.

The interactive sign 102 is a fun and affordable way to express an opinion or promote a person, product, service or event. Organizations that may wish to produce interactive signs 102 could include major sporting leagues, such as the NBA or NFL, corporations, associations, political campaign organizers, independent sales organizations, charities, and other marketable entities.

The apparatus 100 includes a frame 106. The frame 106, in different embodiments, could be made of a variety of materials, including plastic, steel, aluminum, and carbon fiber. In one embodiment, the material of which the frame 106 is made is durable, such as a durable plastic. In one embodiment, the frame 106 flexes to allow the interactive sign 102 to be positioned within the frame 106.

The frame 106 can be made in a variety of color combinations. In one embodiment, the frame 106 may include logos or graphics printed onto the frame 106 itself. In another embodiment, the frame 106 is one color or multiple colors. The frame 106 mounts to a display surface, with the back side of the frame facing the display surface. The frame 106 can be quickly mounted on any smooth surface, such as an automobile's side window, rear window, trunk, tailgate on a truck, or any other clean and smooth surface. Other surfaces could include a home or office window, recreational vehicle, trailer or cargo van.

The frame 106 includes four edges 108, 110, 112, 114. The edges of the frame 106 include a top edge 114, a bottom edge 110, a right edge 108, and a left edge 112 (“edges of the frame”). The frame 106 includes a front side and a back side. The front portion of the frame 106 includes an opening 116 sized such that the opening 116 covers at least two opposite edges of the interactive sign 102 to retain the interactive sign 102. In the depicted embodiment, the opening 116 covers four edges 114, 118, 120, 122 of the interactive sign 102 to retain the interactive sign 102.

The frame 106 includes a lip portion positioned along at least one edge of the frame 106. In the depicted embodiment, the lip portion is positioned along three edges of the frame 106, including the left edge 112, the bottom edge 110, and the right edge 108 of the frame 106. In another embodiment, the lip portion is positioned along the top edge 114, the left edge 112, and the right edge 108 of the frame 106. In an additional embodiment, the lip portion is positioned along the top edge 114, the left edge 112, and the bottom edge 110 of the frame 106. In a further embodiment, the lip portion is positioned along the top edge 114, the right edge 108, and the bottom edge 110 of the frame 106. In one embodiment, the lip portion closely conforms to a shape of the interactive sign 102 on three edges of the interactive sign 102. In one embodiment, the lip portion is very thick relative to the thickness of the frame 106. In an alternate embodiment, the lip portion is extremely thin relative to the thickness of the frame 106.

In one embodiment, one edge 114 of the frame 106 is free of a lip portion. In the depicted embodiment, the top edge 114 of the frame 106 is free of a lip portion. One edge 114 of the frame 106 is free of a lip portion in order to allow the interactive sign 102 to be inserted between the frame 106 and the display surface. In the depicted embodiment, where the top edge 114 of the frame 106 is free of a lip portion, the interactive sign 102 is inserted between the frame 106 and the display surface from the top edge 114 of the frame 106, as indicated by the arrow. In another embodiment, the left edge 112 of the frame 106 is free of a lip portion, so the interactive sign 102 is inserted between the frame 106 and the display surface from the left edge 112 of the frame 106. In another embodiment, the right edge 108 of the frame 106 is free of a lip portion. In a further embodiment, the bottom edge 110 of the frame 106 is free of a lip portion.

In another embodiment, the frame 106 includes a lip portion positioned along four edges 108, 110, 112, 114 of the frame 106. In a further embodiment, at least one edge of the frame 106 includes a slot configured to allow insertion or removal of an interactive sign 102. In one embodiment, the slot is positioned along the top edge 114 of the frame 106. In another embodiment, there are slots on the left edge 112 and right edge 108 of the frame 106, allowing an interactive sign 102 to be inserted into or removed from the frame 106 from the right side or the left side.

An adhesive material 124, 126, 128 is connected to the back side of the frame 106. The adhesive material 124, 126, 128 forms a connection to the display surface when mounted to the display surface. In the depicted embodiment, the adhesive material 124, 126, 128 is double sided tape, such as that made by 3M. The tape could be extremely strong and difficult to remove, or it could create a bond that is not difficult to remove. In one embodiment, the adhesive material 124, 126, 128 could be glue applied directly to the back of the frame 106. In other embodiments, the adhesive material 124, 126, 128 could be Velcro, Liquid Nails, or another bonding material. In one embodiment, the adhesive material 124, 126, 128 allows the frame 106 to be affixed to the display surface quickly. In a further embodiment, the adhesive material 124, 126, 128 is easily removed without damaging the surface area. One of skill in the art will recognize other adhesive materials that function to hold the frame 106 to a display surface.

The adhesive material 124, 126, 128 is applied to at least two edges of the frame 106. In one embodiment, the adhesive material 124, 126, 128 is applied on the lip portion of the frame 106. In the depicted embodiment, the adhesive material 124, 126, 128 is applied on the left portion 112, the bottom portion 110, and the right portion 108 of the frame 106. In other embodiments, the adhesive material 124, 126, 128 may only be applied to two portions of the frame 106, such as the left portion 112 and the right portion 108, the left portion 112 and the bottom portion 110, the right portion 108 and the bottom portion 110, the top portion 114 and the bottom portion 110, the top portion 114 and the left portion 112, or the top portion 114 and the right portion 108. In another embodiment, the adhesive material 124, 126, 128 is applied to three edges of the frame 106 on the lip portion of the frame 106. The three portions of the frame 106, in one embodiment, could include the top portion 114, the left portion 112, and the right portion 108 of the frame 106. In another embodiment, the three portions of the frame 106 could include the top portion 114, the left portion 112, and the bottom portion 110 of the frame 106. In a further embodiment, the three portions of the frame 106 could include the top portion 114, the right portion 108, and the bottom portion 110 of the frame 106.

In one embodiment, the edges of the frame 106 are all free of a lip portion. The adhesive material 124, 126, 128 is applied to at least two edges of the frame 106. The thickness of the adhesive material 124, 126, 128 creates the lip portion of the frame 106. In one embodiment, at least one edge of the frame 106 does not have an adhesive material 124, 126, 128 applied.

In one embodiment, the lip and or the adhesive material 124, 126, 128 include a gap between the interactive sign 102 and an outer edge of the frame 106. If the frame 106 is mounted to a display surface where it is exposed to water, rain, or snow, the gap allows water to run out from inside the frame 106, preventing a buildup of water or other condensation. It also allows for air to circulate in around the interactive sign 102, keeping the interactive sign 102 dry and attractive looking.

The interactive sign 102 is placed between the frame 106 and the display surface. A second surface 104 of the interactive sign 102 faces the display surface. In the depicted embodiment, at least part of the lip portion of the frame 106 is sized such that a combined thickness of the lip portion and the adhesive material 124, 126, 128 is greater than a thickness of the interactive sign 102. In one embodiment, the interactive sign 102 is supported by the lip portion of the frame 106. In another embodiment, the thickness of the interactive sign 102 is greater than the thickness of the lip portion of the frame 106, so the interactive sign 102 is supported by the adhesive material 124, 126, 128 and the lip portion of the frame 106. In a further embodiment, the interactive sign 102 is supported solely by resting on the top surface of the adhesive material 126.

In one embodiment, the frame 106 includes a retention apparatus 130 shaped to secure the interactive sign 102. The retention apparatus 130 is connected to an edge 114 of the frame 106 free of a lip portion. The retention apparatus 130 is positioned between the back side of the frame 106 and the display surface. In the depicted embodiment, the retention apparatus 130 is located on the top edge 114 of the frame 106. In other embodiments, as discussed above, the right edge 108, the left edge 112, or the bottom edge 110 of the frame 106 is free of the lip portion. In those embodiments respectively, the retention apparatus 130 is located on the right edge 108, the left edge 112, or the bottom edge 110 of the frame 106. For instance, in one embodiment, the left edge 112 of the frame 106 is free of a lip portion, and has a retention apparatus 130 located on the left edge 112 of the frame 106. In an embodiment where the bottom edge 110 of the frame 106 is free of the lip portion, the retention apparatus 130 will secure the interactive sign 102 from falling out from the frame 106.

In various embodiments, the retention apparatus 130 may be formed of the same material as the frame 106 or different material as the frame 106. For example, in one embodiment, the frame 106 is formed of plastic, and the retention apparatus 130 is formed from a plastic ridge on the top edge 114 of the frame 106. In another embodiment, the frame 106 is formed of plastic, and the retention apparatus 130 is formed of a metal clip. In another embodiment, the frame 106 is formed of wood, and the retention apparatus 130 is made of plastic. In one embodiment, the retention apparatus 130 includes an edge (e.g. 114) that is formed to closely conform to the display surface and the edge (e.g. 114) is flexible enough to allow insertion of the interactive sign 102.

The retention apparatus 130 is shaped differently in different embodiments. In one embodiment, the retention apparatus 130 is a bump or protrusion from the back of the frame 106 on the edge of the frame 106 free of the lip portion. In another embodiment, the retention apparatus 130 is a ridge running along most of the length of the frame 106. In further embodiment, the retention apparatus 130 is a clip. In an additional embodiment, the retention apparatus 130 is a magnet or other type of adhesive material that forms a removable connection with the display surface to allow the interactive sign 102 to be placed between the display surface and the frame 106.

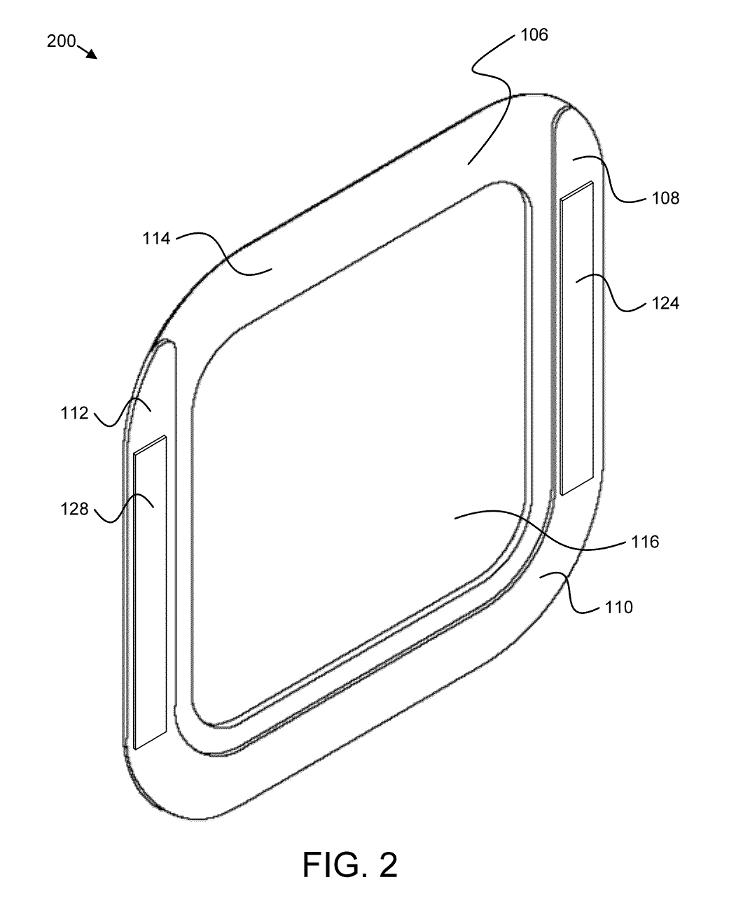

FIG. 2 depicts an angled view of the back side of one embodiment 200 of a frame 106. The frame 106 includes a front side and a back side. The frame 106 includes an opening 116 sized such that the opening 116 covers at least two opposite edges of the first surface of an interactive sign 102 to retain the interactive sign 102. The frame 106 includes a top edge 114, a bottom edge 110, a right edge 108, and a left edge 112. The frame 106 includes a lip portion positioned along three edges 108, 110, 112 of the frame 106. One edge 114 of the frame 106 is free of a lip portion. In other embodiments (not shown), the frame 106 includes only two lip portions, for example along a top edge 114 and a bottom edge 110. In another embodiment (not shown), the frame 106 includes four lip portions where one lip portion includes a slot or recess that allows insertion of the interactive sign 102.

The frame 106, in the depicted embodiment, includes an adhesive material 124, 128 connected to the back side of the frame 106. The adhesive material 124, 128 forms a connection to the display surface when mounted to the display surface. The adhesive material 124, 128 is applied to two or more edges 108, 110, 112 of the frame 106 on the lip portion of the frame 106. At least part of the lip portion of the frame 106 is sized such that a combined thickness of the lip portion and the adhesive material 124, 128 is greater than a thickness of the interactive sign 102.

In the depicted embodiment, there is not adhesive material affixed to the bottom edge 110 of the frame 106. The lip portion of the frame 106 may be of varying thicknesses on the different edges of the frame 106. For example, in the depicted embodiment, the lip portion on the bottom edge 110 of the frame 106 is thicker than the lip portion on the left edge 112 and right edge 108 of the frame 106. The extra thickness of the lip portion compensates for the fact that there is no adhesive material 124, 128 affixed to the bottom edge 110 of the frame 106. In a further embodiment, the lip portion is of uniform thickness on all three edges 108, 110, 112 of the frame 106.

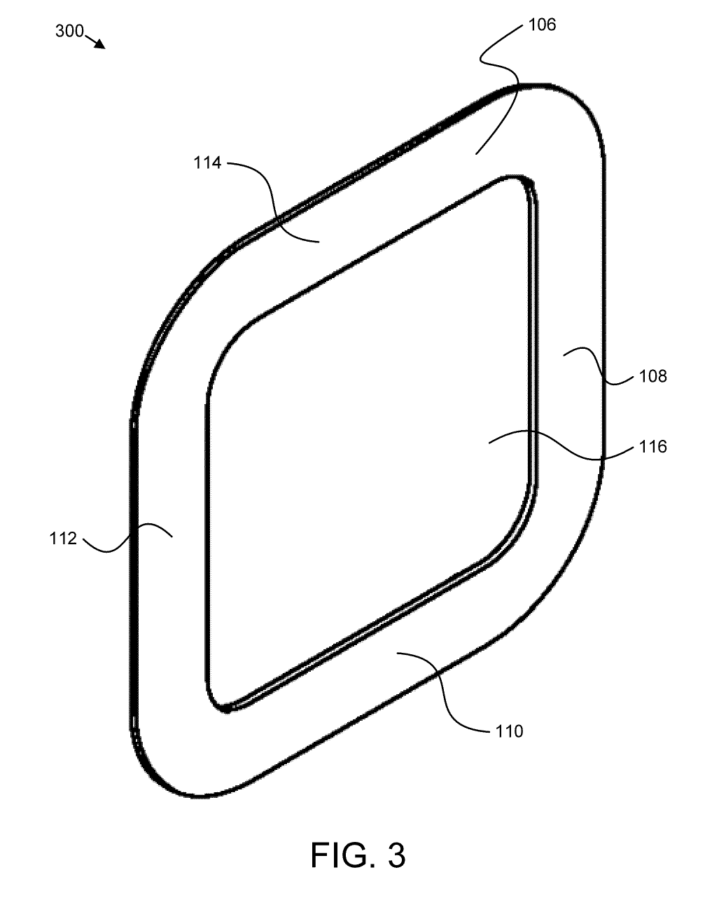

FIG. 3 depicts an angled view of the front side of one embodiment 300 of a frame 106. The frame 106 includes a front side and a back side. The frame 106 includes an opening 116 sized such that the opening 116 covers at least two opposite edges of the first surface of the interactive sign 102 to retain the interactive sign 102. The frame 106 includes a top edge 114, a bottom edge 110, a right edge 108, and a left edge 112. In the depicted embodiment, the edges 108, 110, 112, 114 of the frame 106 are smooth. In a further embodiment, the frame 106 may have a beveled edge. In an additional embodiment, the frame 106 has a textured surface, which may provide an aesthetically pleasing effect. The front side of the frame 106 may include a logo, design, color, or other effect on its surface. The design, color, or information of the front side of the frame 106 may, in one embodiment, correlate to the information on the interactive sign 102 displayed in the frame 106. For example, the frame 106 could have an American flag logo on the front side of it, and the interactive sign 102 includes information about a particular political candidate. In one embodiment, the frame 106 includes a logo or design of the manufacturer stamped or otherwise affixed to one part of the frame 106. In one embodiment, there is a logo and a website URL affixed to the bottom edge 110 of the front of the frame 106.

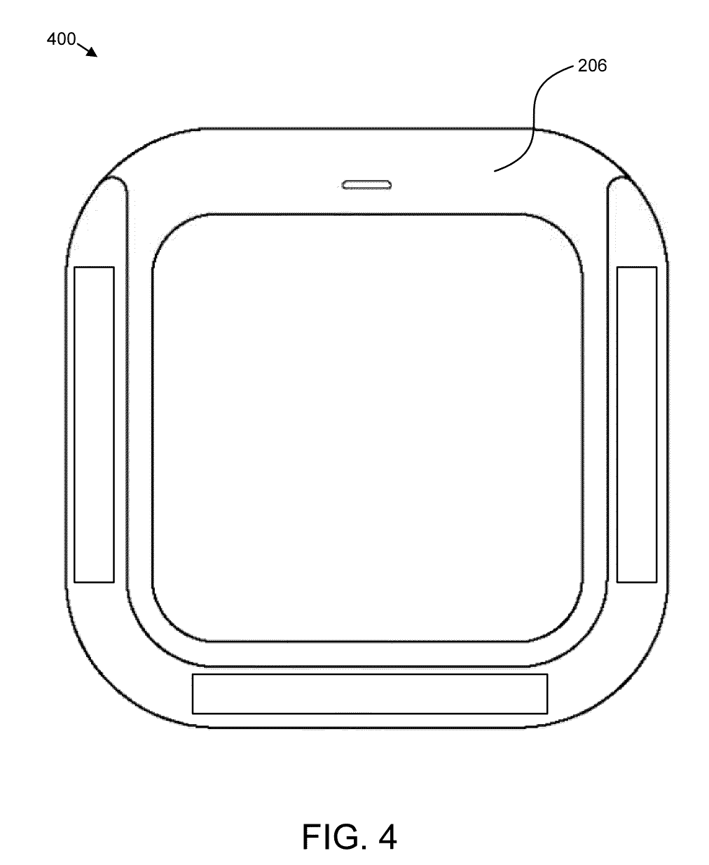

FIG. 4 depicts a back side of one embodiment 400 of a frame 206. The frame 206 depicted in FIG. 4 has many features that are substantially similar to the frame 106 depicted in FIGS. 1-3. The frame 206, in the depicted embodiment, is a square shape. The square shape of the frame 206 allows for a square shaped interactive sign 102 to be mounted. The square shaped interactive sign 102 has many features that are substantially similar to the interactive sign 102 depicted in FIG. 1. In another embodiment, the frame 206 could be a rectangular shape, oval shape, or other shape. In the depicted embodiment, the frame 206 includes rounded corners. In other embodiments, the frame 206 may include square corners, angled corners, a combination of different corners, and the like.

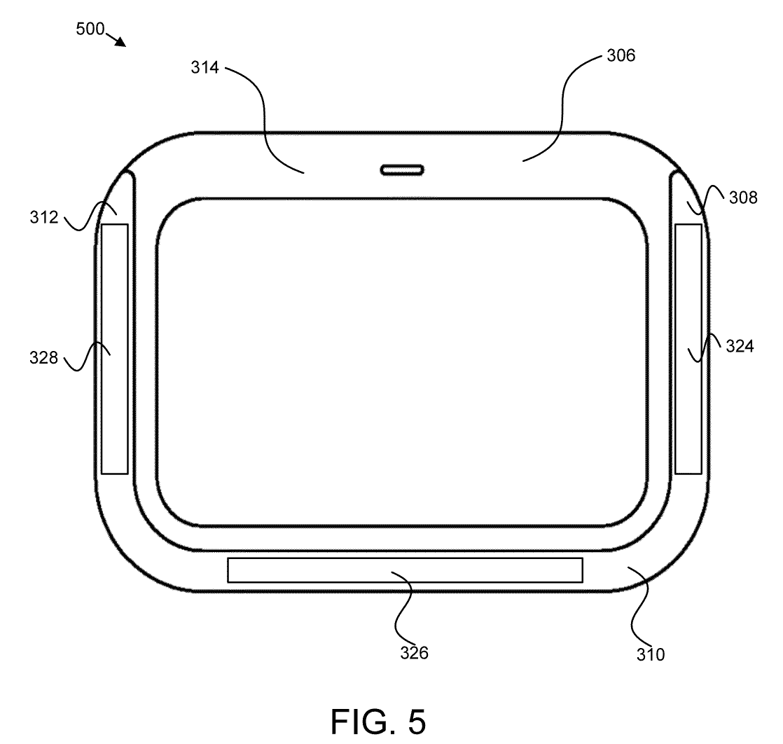

FIG. 5 depicts a back side of an alternative embodiment 500 of a frame 306. The frame 306 depicted in FIG. 5 has many features that are substantially similar to the frame 106 depicted in FIGS. 1-3. In the depicted embodiment, the frame 306 is rectangular shaped. The left edge 312 and right edge 308 of the frame 306 are shorter than the top edge 314 and bottom edge 310 of the frame 306.

The frame 306 includes an adhesive material 324, 326, 328 connected to the back side of the frame 306. In the depicted embodiment, the adhesive material 324, 326, 328 is applied on the lip portion of the frame 306 to the left edge 312, the right edge 308, and the bottom edge 310 of the frame 306. In another embodiment, the adhesive material 324, 326, 328 is applied on a portion 314 of the frame 306 free of a lip portion. In various embodiments, the adhesive material 324, 326, 328 can cover the entire lip, or just a portion of the lip, both in width and in length. The adhesive material 324, 326, 328 can be positioned to form channels to drain water, rain, snow, ice, leaves, debris, or other elements that may come between the back side of the frame 306 and the display surface. In another embodiment, the frame 306 includes a rubber or similar seal around the edge of part of the frame 306 or the edge of the entire frame 306. The rubber or similar seal forms a tight connection to the display surface and keeps rain, snow, water, and other debris or elements from coming between the frame 306 and the display surface.

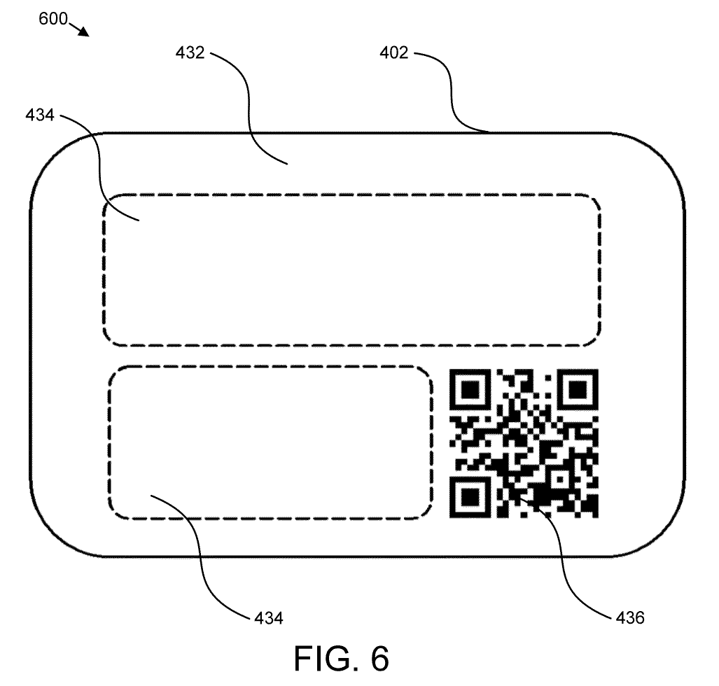

FIG. 6 depicts the first surface of one embodiment 600 of an interactive sign 402. The interactive sign 402 depicted in FIG. 6 has many features that are substantially similar to the interactive sign 102 depicted in FIG. 1. The interactive sign 402 includes a first surface 432 and a second surface. In the depicted embodiment, the interactive sign 402 includes an interactive element 436 that interacts with a mobile scanning device. The interactive element 436, in one embodiment, is located on a surface 432 of the interactive sign 402. In the depicted embodiment, the interactive element 436 is a quick response (“QR”) code. In another embodiment, the interactive element 436 could include one or more of another type of interactive element 436, such as an radio frequency identification (“RFID”) tag, a QR code, a bar code, or the like. One of skill in the art will recognize other interactive technologies that could be used as an interactive element 436.

The interactive sign 402 includes other information 434 printed on the first surface of the interactive sign 402. The information 434 printed on the first surface 432 of the interactive sign 402 could, in various embodiments, include political information, contact information, sales information, pictures, text, designs, a business name, logo, phone number, promotional content, or the like. Other possible information 434 could include graphics of national sports teams, election candidates, for sale signs, astrological signs, realtor signs, business logos, oversized business cards, popular phrases, or any other design or expression that an individual may wish to display. In one embodiment, the interactive sign 402 could include sales information for assisting in the sale of a new or used car, such as the car's make, model, year, mileage, and seller contact information. In another embodiment, the interactive sign 402 could include support for a particular political candidate or platform. The interactive sign 402 is a fun and affordable way to express an opinion or promote a person, product, service or event. Organizations that may wish to produce interactive signs 402 could include major sporting leagues, such as the NBA or NFL, corporations, associations, political campaign organizers, independent sales organizations, charities, and other marketable entities.

In one embodiment, the additional information 434 is printed directly on a surface of the interactive sign 402. In a further embodiment, the additional information 434 is printed on a sheet separate from the interactive sign 402 that is affixed to the surface of the interactive sign 402.

The interactive element 436, in various embodiments, may contain information such as a website uniform resource locator (“URL”), a photograph, a car seller's contact information, other information, or links to other information. The interactive element 436 is capable of being read by a smartphone application, which can be used to convey additional information to the viewer of the interactive sign 402.

In one embodiment, the interactive element 436 is printed directly on a surface of the interactive sign 402. The interactive element 436 could be printed on the surface of the interactive sign 402 at the same time that the rest of the information 434, graphics, or text is printed on the interactive sign 402. In another embodiment, the interactive element 436 is printed onto the interactive sign 402 at a separate time. In a further embodiment, the interactive element 436 is printed on a sheet separate from the interactive sign 402 that is affixed to the surface of the interactive sign 402. The interactive element 436 could be printed on a sticker, a piece of paper, a piece of plastic, a piece of wood, a piece of fabric, or another material capable of being printed on. The interactive element 436 is then affixed to the surface of the interactive sign 402. The interactive element 436 could be affixed to the interactive sign 402 using adhesive, glue, staples, static cling, or another method. In one embodiment, the interactive element 436 is removable from the interactive sign 402. In another embodiment, once the interactive element 436 is affixed to the interactive sign 402, it cannot be removed without damaging or destroying the interactive sign 402.

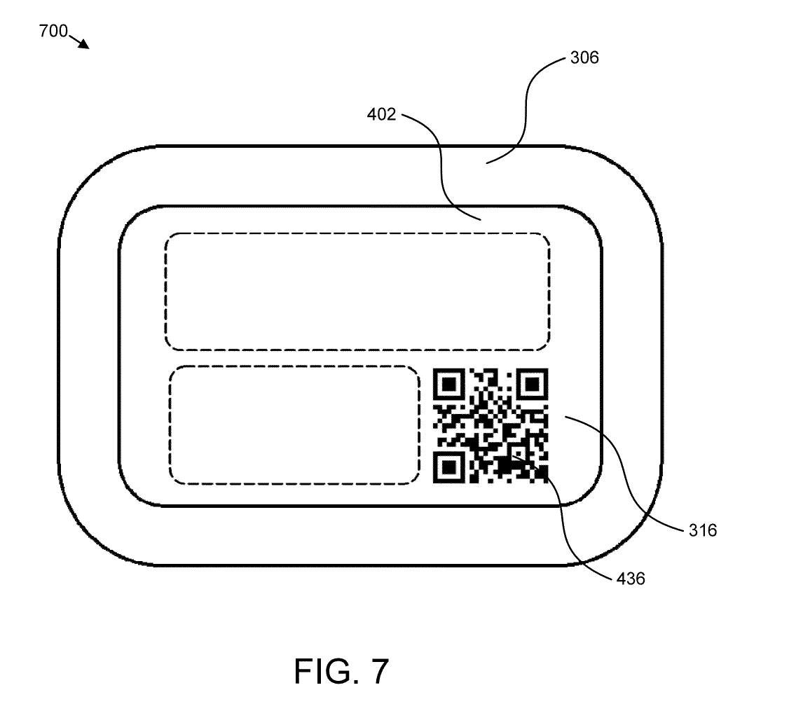

FIG. 7 depicts the front side of one embodiment of an apparatus 700 for displaying an interactive sign 402. In the depicted embodiment, the interactive sign 402 is placed within the frame 306 so that the first surface of the interactive sign 402 can be seen through the opening 316 in the frame 306. The front side of the frame 306 includes an opening 316 sized such that the opening 316 covers at least two opposite edges of the first surface of the interactive sign 402 to retain the interactive sign 402. In the depicted embodiment, the opening 316 covers four edges of the interactive sign 402 to retain the interactive sign 402. In another embodiment, the opening 316 covers less than four edges of the interactive sign 402. For example, in one embodiment, the opening 316 covers two edges of the interactive sign 402—the top edge 314 and the bottom edge 310. In a further embodiment, the interactive sign 402 includes an interactive element 436 that interacts with a mobile scanning device. In an additional embodiment, the interactive element 436 is located on a surface of the interactive sign 402 and within the opening 316 in the frame 306.

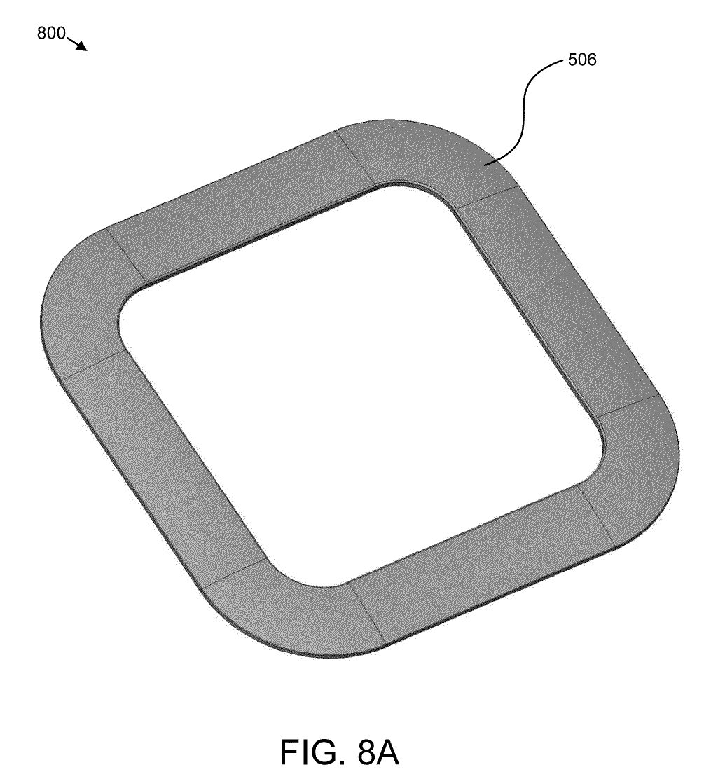

FIGS. 8A and 8B depict one embodiment 800 of a frame 506. The frame 506 depicted in FIGS. 8A and 8B has many features that are substantially similar to the frame 106 depicted in FIGS. 1-3. FIG. 8A depicts a front angled view of the frame 506. The frame 506 in the depicted embodiment is a square shape. In another embodiment, the frame 506 could be a rectangular shape, oval shape, or other shape. In the depicted embodiment, the frame 506 includes rounded corners. Other embodiments may include square corners, angled corners, a combination of different corners, and the like. In the depicted embodiment, the front side of the frame 506 has a smooth beveled edge. In a further embodiment, the frame 506 could include a textured surface, a smooth flat surface, or a combination of surface textures. One of skill in the art will recognize other possibilities for the design and aesthetic features of the frame 506.

FIG. 8B depicts a rear angled view of the frame 506. The frame 506 may be mounted on a display surface so that an edge 514 of the frame 506 free of a lip portion is oriented to the top, to the left, to the right, or to the bottom. The frame 506 includes a retention apparatus 530 that is shaped to secure the interactive sign 102. Even if the frame 506 is mounted so that the edge 514 of the frame free of the lip portion is oriented downwards, the retention apparatus 530 may retain the interactive sign 102 when the interactive sign 102 is mounted within the frame 506.

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a machine readable signal medium or a storage device. The computer readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

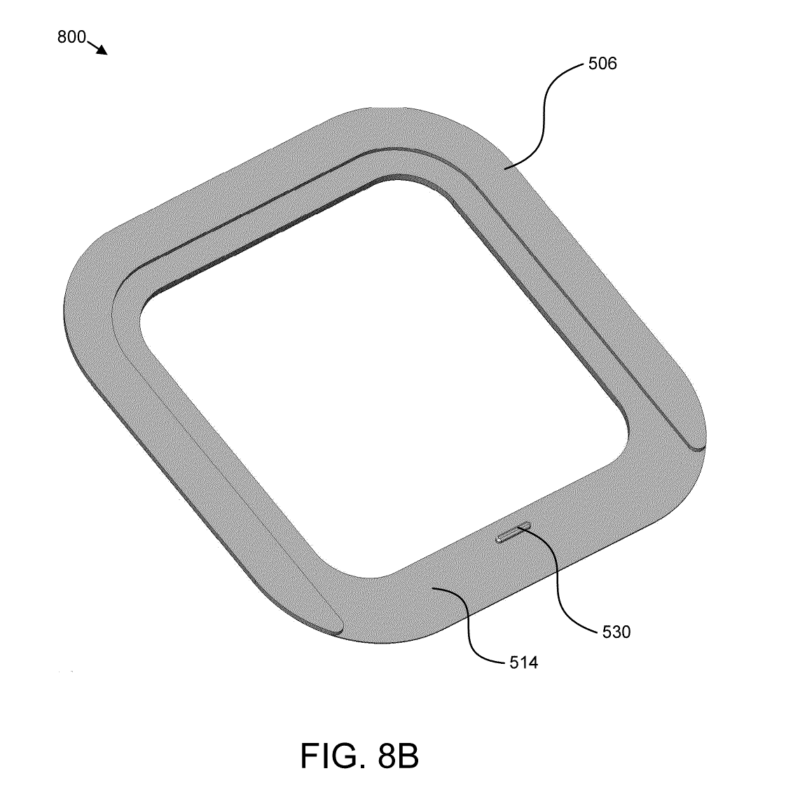

FIG. 9 depicts a system 900 for displaying an interactive sign 402. The system 900 includes an interactive sign 402. The interactive sign 402 includes a first surface and a second surface. The system 900 includes an interactive element 436 associated with a URL for a web page. The web page includes information about an item that includes a display surface. The interactive element 436 is incorporated with a surface of the interactive sign 402. The interactive sign 402 is similar to the interactive sign 102 described above. The interactive sign 402 includes additional information 434.

The system 900 includes a frame 306 that mounts to a display surface for supporting the interactive sign 402. The frame 306 includes a front side and a back side. The back side of the frame 306 faces the display surface. The second surface of the interactive sign 402 faces the display surface. The front side of the frame 306 includes an opening 316 sized such that the opening 316 covers at least two opposite edges of the first surface of the interactive sign 402 to retain the interactive sign 402. The frame 406 includes a top edge 314, a bottom edge 310, a right edge 308, and a left edge 312 (“edges of the frame”). The frame 306 includes a lip portion positioned along at least one edge 308, 310, 312 of the frame.

The system 900 includes an adhesive material 324, 326, 328 connected to the back side of the frame 306. The adhesive material 324, 326, 328 forms a connection to the display surface when mounted to the display surface. The adhesive material 324, 326, 328 is applied to at least two edges of the frame 306. At least part of the lip portion of the frame 306 is sized such that a combined thickness of the lip portion and the adhesive material 324, 326, 328 is greater than a thickness of the interactive sign 402.

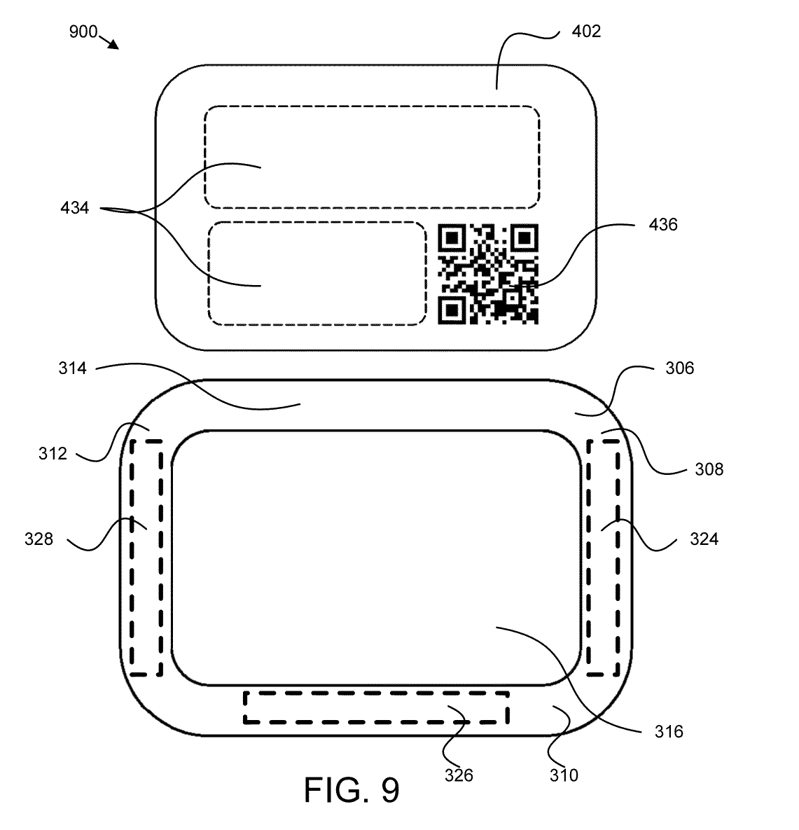

FIG. 10 depicts another embodiment of a system 1000 for displaying an interactive sign 402. The system an interactive sign 402, an interactive element 436, and a frame 306. In one embodiment, the system 1000 includes a URL receiving module 638 that receives a URL of a web page. In a further embodiment, the web page includes information about an item with a display surface. The URL receiving module 638, in various embodiments, could include a computer, a laptop, a mobile cellular phone, a smartphone, a tablet, an iPod, an e-reader, a pager, a digital camera, or another electronic device capable of receiving information or accessing the internet. The URL receiving module 638, in one embodiment, further includes a web browser, application, or some other program capable of receiving information or communicating with the internet.

The system 1000, in one embodiment, includes an interactive element generation module 640 that generates an interactive element 436 associated with the URL. In a further embodiment, the interactive element generation module 640 includes an application or software program that generates a QR code, a bar code, or the like. In another embodiment, the interactive element generation module 640 includes a device for programming RFID tags or the like. In one embodiment, the interactive element generation module 640 includes a printer for printing interactive elements 436 onto stickers. For example, in the depicted embodiment, the interactive element 436 is a QR code printed on an adhesive plastic that as depicted has not yet been incorporated with the interactive sign 402. In another embodiment, the interactive element generation module 640 could print QR codes, bar codes, or other interactive elements 436 onto paper, plastic, fabric, or another material capable of being printed on.

The system 1000, in one embodiment, includes an interactive element incorporation module 642 that incorporates the interactive element 436 generated by the interactive element generation module 640 with a surface of the interactive sign 402. In one embodiment, the interactive element incorporation module 642 includes a device configured to attach stickers or other adhesively affixable interactive elements 436 to interactive signs 402. In one embodiment, the interactive element incorporation module 642 includes a machine that automatically takes interactive elements 436 generated by the interactive element generation module 640 and attaches them to the interactive sign 402. In a further embodiment, the interactive element incorporation module 642 includes a printer. In another embodiment, the interactive element incorporation module 642 prints the interactive element 436 directly onto the interactive sign 402 with all other information, graphics, or text that is included on the interactive sign 402. In a further embodiment, the interactive element incorporation module 642 includes a person who incorporates an interactive element 436 with an interactive sign 402. In another embodiment, the interactive element incorporation module 642 includes a workstation, device, or place where the interactive element 436 is incorporated with an interactive sign 402.

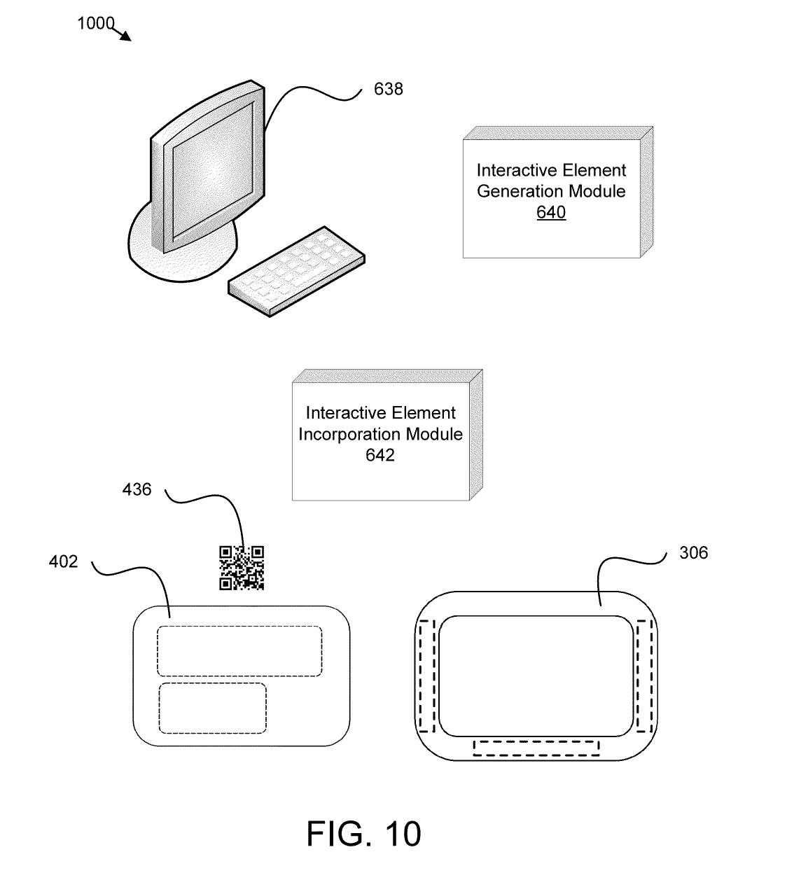

FIG. 11 depicts a method 1100 for displaying an interactive sign 402. The method 1100 begins, and the URL receiving module 638 receives 710 a URL for a web page. The web page could include a web page listing. A web page listing typically includes information about an item including a display surface. The web page listing could be an online classified ad, such as one on Craigslist.org. In another embodiment, the web page listing could include a listing on an item sale or auction site, such as Cars.com, eBay.com, or the like. In a further embodiment, the web page could include a manufacturer product information page, a fan page, a collector club page, or another web page relevant to the item with the display surface. The item with a display surface could be a car, a truck, a house, a boat, a trailer, a camper, an RV, or anything else with a smooth surface.

The interactive element generation module 640 generates 712 an interactive element associated with the URL. The interactive element could include a QR code, a bar code, an RFID tag, or the like. Generating 712 the interactive element, in one embodiment, includes encoding the URL into a QR code. In a further embodiment, generating 712 the interactive element includes printing out a QR code, a bar code, or the like. In an additional embodiment, generating 712 the interactive element includes encoding the URL information onto an RFID tag or the like. In other embodiments using other interactive technology, which are known to one of skill in the art, the generating 712 includes encoding or otherwise generating an interactive element associated with the URL.

The interactive element incorporation module 642 incorporates 714 the interactive element with a surface of the interactive sign 402. In one embodiment, incorporating 714 includes affixing a printed QR code, bar code, or the like to the surface of the interactive sign 402. In another embodiment, incorporating 714 includes affixing an RFID tag or the like to a first or second surface of the interactive sign 402. In a further embodiment, incorporating 714 includes printing the interactive element directly on the surface of the interactive sign 402. The interactive element could be printed on the surface of the interactive sign 402 at the same time that other information is printed onto the interactive sign 402, or at a different time.

The frame 306 supports 716 the interactive sign 402 on a frame 306 mounted to the display surface of the item. The interactive sign 402 includes a first surface and a second surface. The second surface of the interactive sign 402 faces the display surface. The frame 306 includes a front side and a back side. The back side of the frame 306 includes an opening 316 sized such that the opening 312 covers at least two opposite edges of the first surface of the interactive sign 402 to retain the interactive sign 402. The frame 306 includes a top edge 314, a bottom edge 310, a right edge 308, and a left edge 312 (“edges of the frame”). The frame 306 includes a lip portion positioned along at least one edge of the frame 306.

The frame 306 includes an adhesive material connected to the back side of the frame 306. The adhesive material forms a connection to the display surface when mounted to the display surface. The adhesive material is applied to at least two edges of the frame 306. At least part of a lip portion of the frame 306 is sized such that a combined thickness of the lip portion and the adhesive material is greater than a thickness of the interactive sign 402.

In one embodiment, the interactive sign 402 is positioned between the display surface of the item and the back side of the frame 306. In an additional embodiment, the frame 306 supports the interactive sign 402 on the frame 306. In another embodiment, the frame 306 includes a slot configured to receive the interactive sign 402. In a further embodiment, the interactive sign 402 slides into the slot, the slot positioned along one or more of the edges of the frame 306. The method 1100 ends.

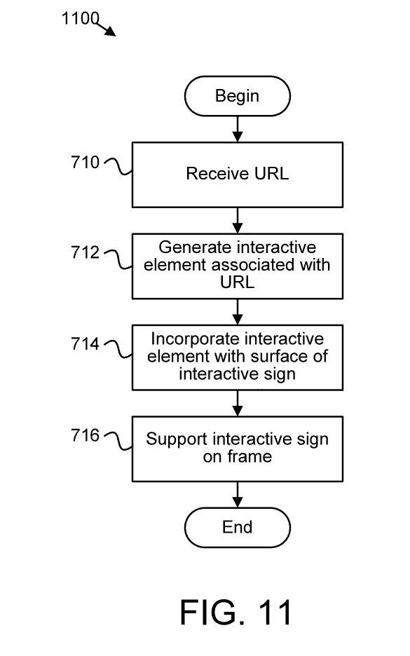

FIG. 12 depicts a close up view of the lower left corner of one embodiment 1200 of the rear side of a frame 806. The frame 806 depicted in FIG. 12 has many features that are substantially similar to the frame 106 depicted in FIGS. 1-3. In the depicted embodiment, the frame 806 includes a compartment 844 configured to receive an RFID tag 846. In another embodiment, a different kind of interactive element similar to an RFID tag 846, known to one of skill in the art, may be used. In one embodiment, the compartment 844 is sealed with the RFID tag 846 inside. In another embodiment, the compartment 844 has a cover, which when removed allows an RFID tag 846 to be placed inside the frame 806. In different embodiments, the cover may include hinges, may snap into place, or may be affixed to the frame 806 using adhesive or some other material that holds the cover in place. In a further embodiment, the compartment 844 may be an exposed opening, with a retaining clip to which the RFID tag 846 attaches. In an additional embodiment, the compartment 844 is an exposed opening with an adhesive substance or coating on the inside to which the RFID tag 846 adheres.

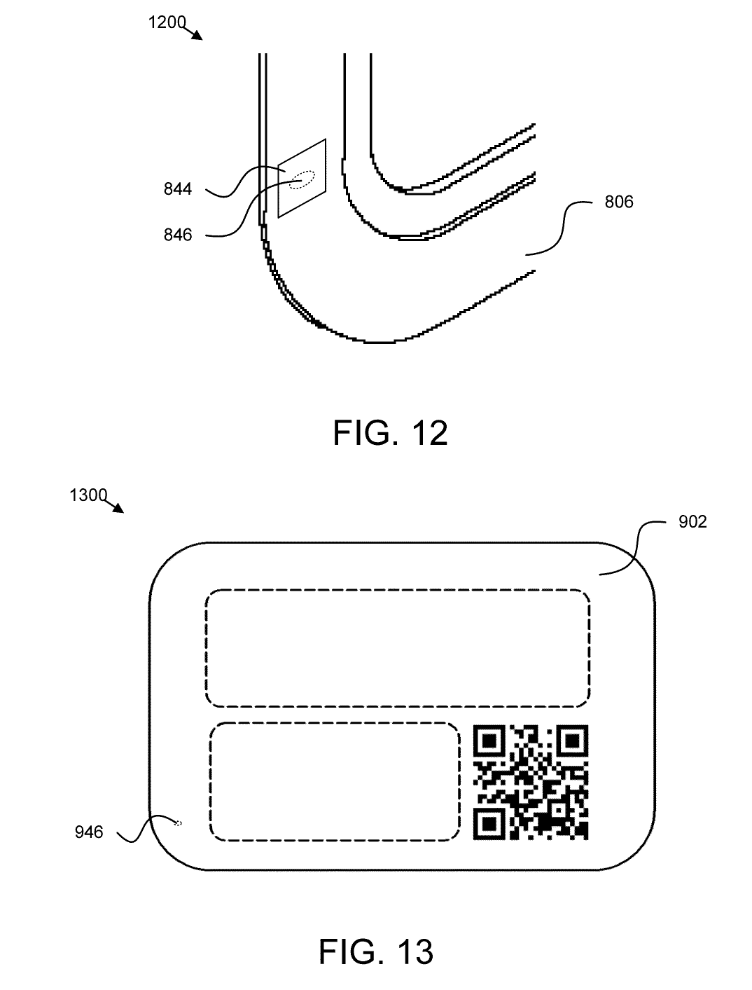

FIG. 13 depicts an embodiment 1300 of an interactive sign 902 that includes an interactive element, such as an RFID tag 946. In one embodiment, the RFID tag 946 is substantially similar to the RFID tag 846 of FIG. 12. The interactive sign 902 depicted in FIG. 13 has many features that are substantially similar to the interactive sign 102 depicted in FIG. 1. One of skill in the art will recognize that the interactive element may include another technology in addition to or instead of an RFID tag 946. The RFID tag 946 is glued, taped, or otherwise affixed to a surface of the interactive sign 902. The RFID tag 946 may be attached to the first surface or the second surface of the interactive sign 902. The RFID tag 946 may be attached to the interactive sign 902 on a part of the interactive sign 902 that is covered by a frame 106, or on the surface of the interactive sign 902 that is facing the display surface and is not exposed to view. The RFID tag 946 can be read by a device capable of reading RFID tags 946, such as a smartphone or the like.

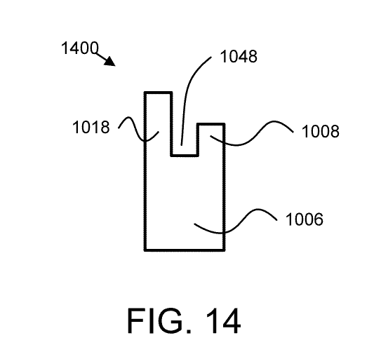

FIG. 14 depicts a cross section of one portion 1400 of a frame 1006. The frame 1006 depicted in FIG. 14 has many features that are substantially similar to the frame 106 depicted in FIGS. 1-3. In the depicted embodiment, the lip portion 1008 of the frame 1006 includes a slot 1048 configured to receive the interactive sign 102. The slot 1048 is positioned along one or more edges of the frame 1006. The slot 1048 is created by a depression between the lip portion 1008 and the portion 1018 of the frame 1006 that forms the opening in the frame 1006.

In the depicted embodiment, the portion 1018 of the frame 1006 is the front side of the frame and the lip portion 1008 of the frame 1006 is the back side of the frame 1006. In one embodiment, the bottom edge 110, the left edge 112, and the right edge 108 of the frame 1006 include a slot 1048. The top edge 114 of the frame 1006, in one embodiment, is free of a lip portion 1008 and is also free of a slot 1048. This configuration allows an interactive sign 102 to be inserted and secured in the frame 1006. In another embodiment, there is only a slot 1048 on two edges of the frame 1006, such as the left edge 112 and the right edge 108.

In another embodiment, where an edge of the frame free of the lip portion 1008 is on an edge of the frame 1006 other than the top edge 114 of the frame 1006, that portion of the frame 1006 is also free of a slot 1048. In another embodiment, the lip portion 1008 extends around all the edges of the frame 1006, and the slot 1048 on one or more edges of the frame 1006 extends to the outer edge of the frame 1006 so as to allow the insertion and removal of the interactive sign 102.

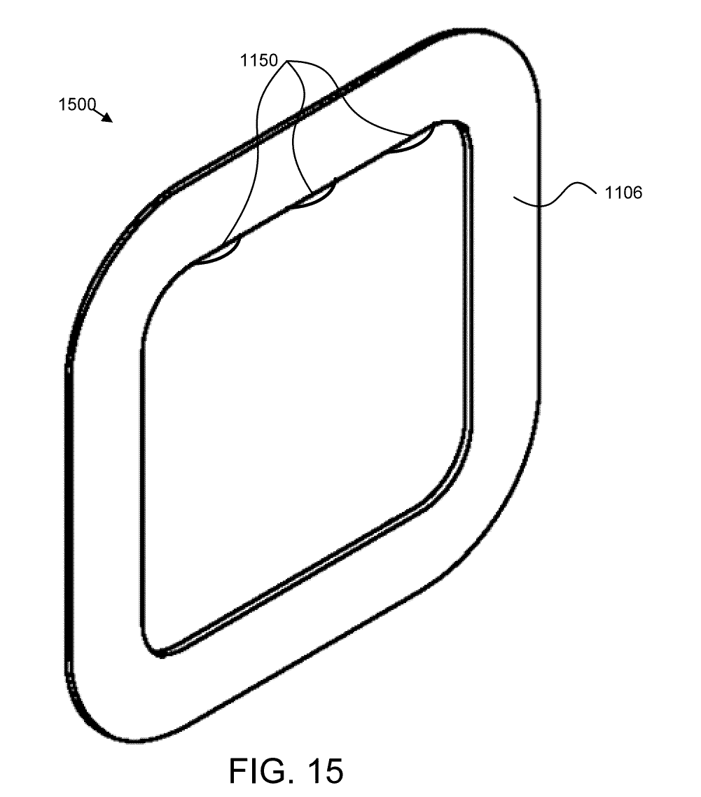

FIG. 15 depicts an embodiment of the apparatus 1500 that includes lights 1150 integrated with the frame 1106. The frame 1106 depicted in FIG. 15 has many features that are substantially similar to the frame 106 depicted in FIGS. 1-3. In different embodiments, there could be one or more lights 1150. The lights 1150 are integrated with the frame 1106, and positioned to project light onto a surface of the interactive sign 102. In the depicted embodiment, the lights 1150 are integrated on the top portion of the frame 1106. In other embodiments, one or more lights 1150 could be integrated on the top portion, the left portion, the right portion, the bottom portion, or a combination of different portions of the frame 1106. In different embodiments, the lights 1150 could be light emitting diodes (“LEDs”), organic light-emitting diodes (“OLEDs”), light-emitting capacitors (“LECs”), liquid crystal displays (“LCDs”), cold-cathode fluorescent lamps (“CCFLs”), cold cathode devices, or the like. The lights 1150, in one embodiment, provide light to make it easier to view the interactive sign 102 mounted within the frame 1106.

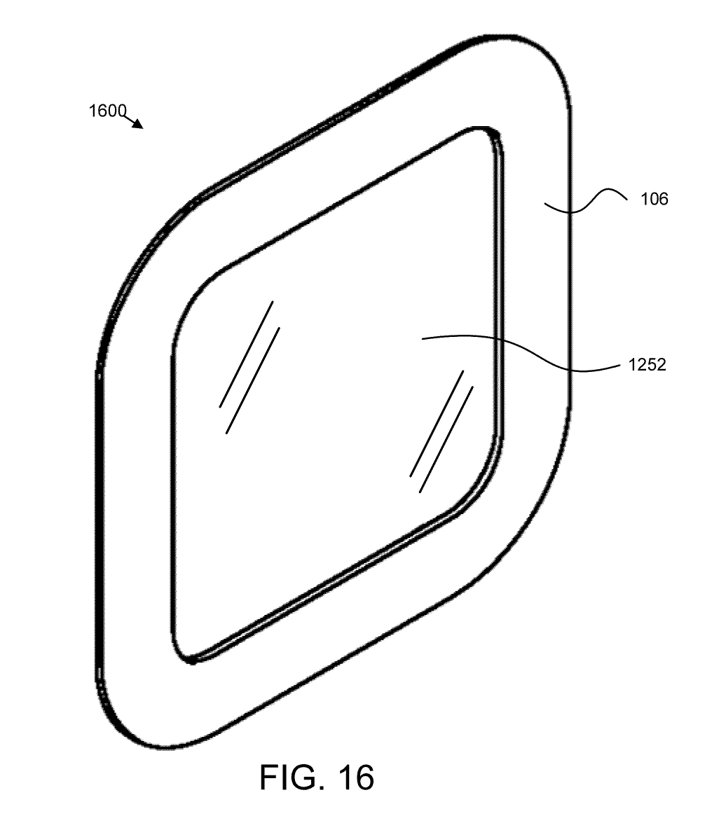

FIG. 16 depicts one embodiment of the apparatus 1600 that includes a transparent element 1252 sized to fit the opening 116 of the frame 106 so as to fill either the entire opening 116 or a portion thereof. The transparent element 1252 serves to protect the interactive sign 102 from water, light, and other weather conditions. The transparent element 1252 could be made out of plastic, glass, plexiglass, or another transparent material. The transparent element 1252 may be smooth, textured, include small holes like pinholes, or the like. The transparent element 1252 could be permanently built into the frame 106, or be removable. In the depicted embodiment, the frame 106 and transparent element 1252 snap together.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus for displaying an interactive sign, the apparatus comprising:
a frame that mounts to a display surface for supporting an interactive sign, the sign comprising a first surface and a second surface, the second surface facing the display surface, the frame comprising a front side and a back side, the back side of the frame facing the display surface, the front side of the frame comprising an opening sized such that the opening covers at least two opposite edges of the first surface of the interactive sign to retain the interactive sign, the frame comprising a top edge, a bottom edge, a right edge, and a left edge (“edges of the frame”), the frame comprising a lip portion positioned along at least one edge of the frame;
an adhesive material connected to the back side of the frame, the adhesive material forming a connection to the display surface when mounted to the display surface, the adhesive material applied to at least two edges of the frame; and
wherein at least part of the lip portion of the frame is sized such that a combined thickness of the lip portion and the adhesive material is greater than a thickness of the interactive sign.

2. The apparatus of claim 1, the apparatus further comprising a retention apparatus shaped to secure the interactive sign, the retention apparatus connected to an edge of the frame free of a lip portion and positioned between the back side of the frame and the display surface.

3. The apparatus of claim 1, wherein the interactive sign comprises an interactive element that interacts with a mobile scanning device.

4. The apparatus of claim 3, the interactive element comprising one or more of a quick response (“QR”) code, a bar code, and an radio frequency identification (“RFID”) tag.

5. The apparatus of claim 3, the interactive element located on a surface of the interactive sign and within the opening in the frame.

6. The apparatus of claim 3, wherein the interactive element is one of printed directly on a surface of the interactive sign and printed on a sheet separate from the interactive sign that is affixed to a surface of the interactive sign.

7. The apparatus of claim 3, wherein the frame comprises a compartment configured to receive an RFID tag.

8. The apparatus of claim 1, wherein the frame flexes to allow the interactive sign to be positioned within the frame.

9. The apparatus of claim 1, wherein the frame comprises a lip portion positioned along four edges of the frame, at least one edge of the frame comprising a slot configured to allow insertion or removal of an interactive sign.

10. The apparatus of claim 1, wherein the adhesive material is applied to three edges of the frame on the lip portion of the frame.

11. The apparatus of claim 1, wherein one or more of the lip and the adhesive material comprises at least one gap between the interactive sign and an outer edge of the frame.

12. The apparatus of claim 1, wherein the opening covers four edges of the interactive sign to retain the interactive sign.

13. The apparatus of claim 1, wherein the lip portion of the frame comprises a slot configured to receive the interactive sign, the slot positioned along one or more of the edges of the frame.

14. The apparatus of claim 1, the apparatus further comprising one or more lights integrated with the frame positioned to project light onto a surface of the interactive sign.

15. The apparatus of claim 14, wherein the one or more lights comprise one or more of light emitting diodes (“LEDs”), organic light-emitting diodes (“OLEDs”), light-emitting capacitors (“LECs”), liquid crystal displays (“LCDs”), cold-cathode fluorescent lamps (“CCFLs”), and cold cathode devices.

16. The apparatus of claim 1, the apparatus further comprising a transparent element sized to fit inside the opening of the frame so as to fill one of a portion of the opening and the entire opening.

17. A method for displaying an interactive sign, the method comprising:
receiving a uniform resource locator (“URL”) for a web page, the web page comprising information about an item comprising a display surface;
generating an interactive element associated with the URL;
incorporating the interactive element with a surface of an interactive sign; and
supporting the interactive sign on a frame mounted to the display surface of the item.

18. The method of claim 17, wherein:
the frame mounted to the display surface of the item supports an interactive sign, the sign comprising a first surface and a second surface, the second surface facing the display surface, the frame comprising a front side and a back side, the back side of the frame facing the display surface, the front side of the frame comprising an opening sized such that the opening covers at least two opposite edges of the first surface of the interactive sign to retain the interactive sign, the frame comprising a top edge, a bottom edge, a right edge, and a left edge (“edges of the frame”), the frame comprising a lip portion positioned along at least one edge of the frame;
wherein the frame further comprises:
an adhesive material connected to the back side of the frame, the adhesive material forming a connection to the display surface when mounted to the display surface, the adhesive material applied to at least two edges of the frame; and
wherein at least part of the lip portion of the frame is sized such that a combined thickness of the lip portion and the adhesive material is greater than a thickness of the interactive sign.

19. A system for displaying an interactive sign, the system comprising:
an interactive sign, the sign comprising a first surface and a second surface;
an interactive element associated with a URL for a web page, the web page comprising information about an item, the item comprising a display surface, the interactive element incorporated with a surface of the interactive sign;
a frame that mounts to a display surface for supporting the interactive sign, the frame comprising a front side and a back side, the back side of the frame facing the display surface, the second surface of the interactive sign facing the display surface, the front side of the frame comprising an opening sized such that the opening covers at least two opposite edges of the first surface of the interactive sign to retain the interactive sign, the frame comprising a top edge, a bottom edge, a right edge, and a left edge (“edges of the frame”), the frame comprising a lip portion positioned along at least one edge of the frame;
an adhesive material connected to the back side of the frame, the adhesive material forming a connection to the display surface when mounted to the display surface, the adhesive material applied to at least two edges of the frame; and
wherein at least part of the lip portion of the frame is sized such that a combined thickness of the lip portion and the adhesive material is greater than a thickness of the interactive sign.

20. The system of claim 19, the system further comprising:
a URL receiving module that receives a URL of a web page, the web page comprising information about an item comprising a display surface;
an interactive element generation module that generates an interactive element associated with the URL; and
an interactive element incorporation module that incorporates the interactive element generated by the interactive element generation module with a surface of the interactive sign.
